(19) United States
(12) Patent Application Publication
(10) Pub. No.: US 2006/0220837 A1
(43) Pub. Date: Oct. 5, 2006

(54) Identification badge with wireless audio alert capabilities

(76) Inventor: Douglas Kozlay, Timonium, MD (US)

Correspondence Address: DOUGLAS KOZLAY, 9475 DEERECO RD. #304, TIMONIUM, MD, 21093, US

(21) Appl. No.: 11/084,588

(22) Filed: Mar. 18, 2005

(51) Int. Cl. G08B 1/08

(52) U.S. Cl. 340/539.11; 340/5.82; 340/7.21

(57) ABSTRACT

An identification badge apparatus, method, and system are disclosed. The apparatus has radio reception capabilities for receiving audio alerts from alert origination facilities, e.g., local and/or central badge monitoring console(s). One optional version of the apparatus includes a biometric authentication sensor. Apparatus output components include a receiver and a loudspeaker; optional input components include a microphone and a transceiver for sending responses back to alert originators. Typical applications include user authentication; presence detection; proximity sensing; alarms; paging; etc. Other applications include personnel and vehicle monitoring; asset tracking; and others where audio feedback supports application objectives. The invention is customizable for one-way or for two-way feedback applications. Application managers are typically security offices; medical personnel; battlefield commanders; and first responders (police, firemen, ambulance, etc.). Audio feature “management” and user authentication can be “user-side”, and/or “management-side”, to better interface users and their managers.

### BACKGROUND OF THE INVENTION

1. Field of the Invention

The field of the invention is advanced wireless identification badges (cards). More particularly, the field of the invention is identification badges with wireless one-way or two-way audio alert reception capabilities. Also, the present invention addresses such badges having wireless audio alert reception capabilities, plus biometric authentication capabilities.

2. Related Art

There appears to be no exactly related art. The Inventor is aware of security-oriented wireless appliances with various “audio” capabilities; but there appears to be no wireless identification badges with audio message/audio alert reception features analogous to those of the present invention. One typical non-analogous product with wireless audio alert reception features is the so-called Blackberry® communicator by “Research In Motion”. Blackberry® is a communicating PDA (personal data assistant) product capable of sending and receiving messages. Another similar product to Blackberry® is the Blueberry®—also a communicating PDA—that adds cellular telephone capabilities (also by Research In Motion).

U.S. Pat. No. 5,623,552 to Lane discloses a self-authenticating identification card including a fingerprint sensor for authenticating the identity of a user. Lane teaches an ID card with a memory that stores data relating to a fingerprint of a card user. An on-card authenticator compares data about a sensed fingerprint with stored fingerprint data, then generates an authentication signal if the sensed fingerprint data matches stored fingerprint data. An audio generator can be included within the card. The onboard audio generator sends an audio signal to the onboard speaker, if a match is sensed. By comparison to the present invention, the audio alert capabilities of this particular product are “canned”—i.e., completely stored entirely aboard the card itself—unlike the remote audio alert capabilities of the present invention. A programmable magnetic stripe can also be used to store data related to the card user. A magnetic stripe programmer can enable the programmable magnetic stripe if sensed fingerprint data matches stored fingerprint data.

Despite ostensible benefits provided by the Lane patent and the product it protects, this patent is not analogous art to the present invention because it teaches an audible signal originating inside of the card—which is programmed within the card—that can either (a) indicate that the card's user's fingerprint information (template) has been successfully stored in the memory of the card; or (b) indicate that an inputted prospective user's fingerprint matches the electronically stored fingerprint information applicable to that prospective user's fingerprint. The audio alert capabilities of this particular product appear to be “canned”—i.e., completely stored entirely aboard the card itself.

By contrast, the badge of the present invention (once enabled) establishes a radio channel between the speaker (and optionally, a microphone) on the badge and a corresponding microphone (and optionally, a speaker) at a monitoring console (e.g., a local and/or central station) capable of transmitting to (and optionally receiving from) the badge in order to communicate audible messages including audio alerts.

In further contrast to the Lane patent and its' apparent product—messages (and/or audio alerts) transmitted to/from the badge of the present invention are not merely indicative of fingerprint storage or authentication status—i.e., “on-card” events—but rather, can be any message(s) the alert origination console deems necessary to convey to one or more badgeholders. Furthermore, in the present invention, messages and alerts transmitted to the badge can include remotely-originated, “live”, programmed, and/or pre-programmed messages of any kind. Messages transmitted to the badge can also include audible (verbal or data) communications from persons, other badges, and/or other machines. Messaging/alerting which is remotely originated and transmitted to the badge of the present invention, can also include messages/alerts provided by other badges/badgeholders on and/or off a “local” control console (i.e., the immediately proximate “local” network). In the case of messages forwarded into the local badge interface network from “non-local” consoles or networks, messages and/or alerts are forwarded to “local” badgeholder(s) via the immediately-proximate control console and (e.g.) its' upstream connections, i.e., upstream console(s) and/or network(s).

Notwithstanding, to achieve “two-way” communications, additional components are required on the badge of the present invention (i.e., an optional “on-badge” transceiver and an optional “on-badge” microphone). Two-way communicating versions of badges of the present invention can be operated in many different ways (i.e., badgeholder to a center console; badgeholder to badgeholder directly; badgeholder to badgeholder via the control console, etc.).

### NECESSITY OF THE INVENTION

Emergency responders, medical caregivers and other organizational employees need to be paged and to communicate throughout the day. It is not always desirable for such people to carry and activate a cell phone nor is it convenient to answer one at all times. There is a need for an authorized badgeholder's unique badge to perform the additional tasks of providing corporate communication as well as optionally authenticating the identity of the badgeholder. This eliminates the need for annoying building-wide paging followed by a search by the paged badgeholder to find a local phone to respond. Based on the nominally-related yet non-analogous art discussed immediately preceding, identification cards and badges are well known in the art; however, such products would have many new or improved uses, if remote audio messaging and audio alerting capabilities were available therewith, as taught and disclosed herein. Based on references observed and cited, it appears that there are no “card-form-factor” wireless identification badges which also have the communications capabilities and the optional badgeholder identification capabilities of the present invention.

Accordingly, there is a need in the art for badges which can communicate either “one-way” or “two-way” between a central station (e.g., a badge monitoring/alerting console) and one or more badgeholders. There also appears to be a need in the art for badges which can communicate from one badgeholder to another badgeholder, and which can communicate diverse types of messages from one badgeholder and/or badge monitoring and alert origination console(s)—e.g., local and/or central monitoring and control station(s)—to many other badgeholders.

### OBJECTS OF THE INVENTION

Accordingly, one primary object of the invention is to provide an identification badge (a.k.a., an identification card) with audio output and audio interface capabilities, with “one-way” reception capabilities for receiving audio alerts from audio originators (e.g., control stations, badge monitoring consoles, etc.). It is a related primary object, to provide an identification badge with “two-way” transmission and reception capabilities (i.e. having both audio input and audio output interface capabilities), adapted for receiving audio alerts from audio originators, and for transmitting audio responses to audio originators and/or other badges of the present invention). It is a related object, to provide an identification badge with audio messaging and audio alert capabilities. It is another related object, to provide an identification badge with both audio input and audio output interface capabilities, as well as other communication capabilities.

It is another primary object of the invention, to provide an identification badge, with multiple different types of badgeholder identification and authentication capabilities; i.e., multiple “conventional” identification capabilities (such as multiple badgeholder-identifying indicia). It is yet another related primary object, to provide optional, “advanced” badgeholder identification capabilities (e.g., biometrics including fingerprint-based authentication; voice-based authentication; heartbeat-based authentication; etc.).

It is yet another primary object, to provide an identification badge-based alerting, alarming, and messaging system for use with identification badges having audio output or audio input/output capabilities. It is a related object, to provide an audio input verification system (e.g., for verifying voice inputs, audio steganographic inputs, etc.) as part of an identification badge-based alerting, alarming, and messaging system. It is yet another related object, to provide a centralized and/or distributed communications system for interfacing identification badges.

It is another primary object, to provide a method for enrolling an authorized badgeholder into an identification badge. It is a related primary object, to provide a method for establishing a communications system for transmitting and receiving alerts, alarms, and messages to and from identification badges and a badge monitoring/alerting console, and between and among identification badges.

It is another object of the invention (in the case of the “two-way” communication version of the invention only), to provide a badge-based alert origination capability for initiating audio alerts and for transmitting badge-originated audio alerts to other badgeholders and/or monitoring console(s).

### SUMMARY OF THE INVENTION

The present invention was inspired by the apparent need for providing audio alert reception capabilities in identification badges, allowing reception of remotely-originated messages of many types. Typically, the identification badge apparatus of the present invention is adapted for reception of remotely-originated messages such as alert messages, alarm messages, voice messages, data messages, other messages, etc.

Accordingly, the system of the present invention teaches transmission of remotely-originated messages from one or more (local or remote, centralized or distributed) control stations (typically badge monitoring/alerting/messaging consoles) to one or more identification badges of the present invention. Communicating remotely-originated messages from control stations to badges of the present invention is done via wireless radio, and/or wireless infrared, and/or spread spectrum transmissions, or other wireless techniques.

To summarize the apparatus of the present invention, audio output components include a speaker for outputting remotely-originated messages received by an “on-badge” receiver. In higher-function versions of the identification badge apparatus, an optional microphone can receive external audio inputs (e.g., voice inputs or other audio) from a badgeholder or other source. The microphone's audio inputs are picked up by an “on-badge” transceiver, which transmits such audio inputs out from the badge to one or more transmission or broadcast destinations (e.g., to control console(s) and/or to one or more similarly-configured identification badges).

Additionally, advanced versions of the badge with optional audio input features can also be used as an input source for audio input verification applications (e.g., biometric voice recognition; audio tone recognition; etc.). Necessarily, such advanced versions must directly or indirectly process the audio inputs to analyze and/or verify them as needed for any specific implemented application.

Furthermore, some versions of the invention can also optionally add, e.g., a unique serial number, and/or corporate employee identifier (or other uniquely-addressable identifier) to the memory of the processor of the identification badge, thereby adding unique addressability features, i.e., “badge-specific addressability”, permitting control console(s) to explicitly select and address one or more badges as destinations for remotely-originated messages. In the case of Bluetooth digital audio transmission, for example, each device can be communicated with according to the Bluetooth standard. Other transmission protocols, well known to the art, provide an addressable receiver capability based upon a digital number stored in the card. The benefit is that each badge can be individually addressed, and/or all badges can be simultaneously addressed in a broadcast. In conclusion, these features allow one or more badgeholders to establish bilateral dialogues with either the control console and/or with other badgeholders, via advanced versions of the identification badge apparatus of the present invention.

### DETAILED DESCRIPTION OF THE INVENTION

### Brief Description of the Drawings and Reference Numerals

FIG. 1 shows an alert being sent to multiple badgeholders from a central alert generation and origination station (a.k.a., an alerting and monitoring console).

FIG. 2 overviews basic internal components of the identification badge

FIG. 3 overviews a user fingerprint authentication event by an identification badge

FIG. 4 shows a close-up of the identification badge, receiving an audio alert

FIG. 5 shows the selection of a unique fireman for two-way communications.

### REFERENCE NUMERALS

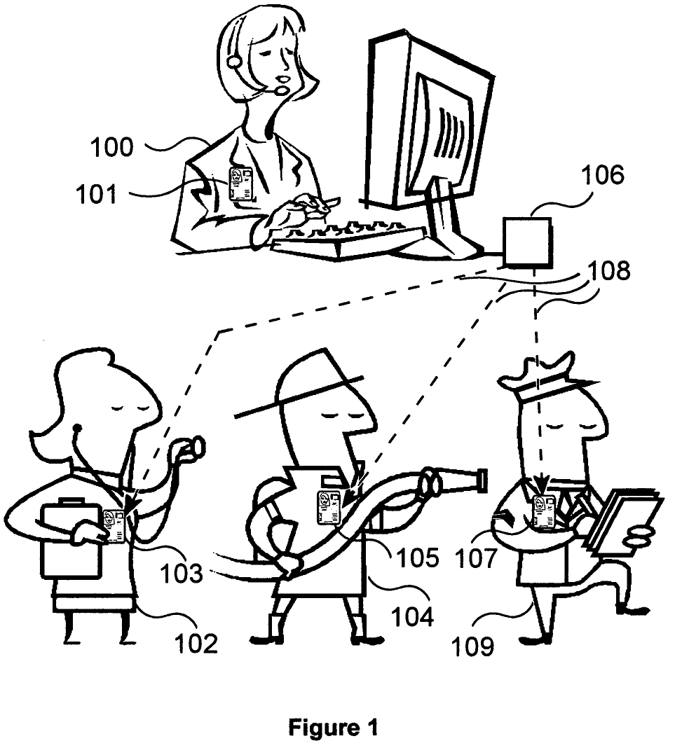

FIG. 1 Numerals:

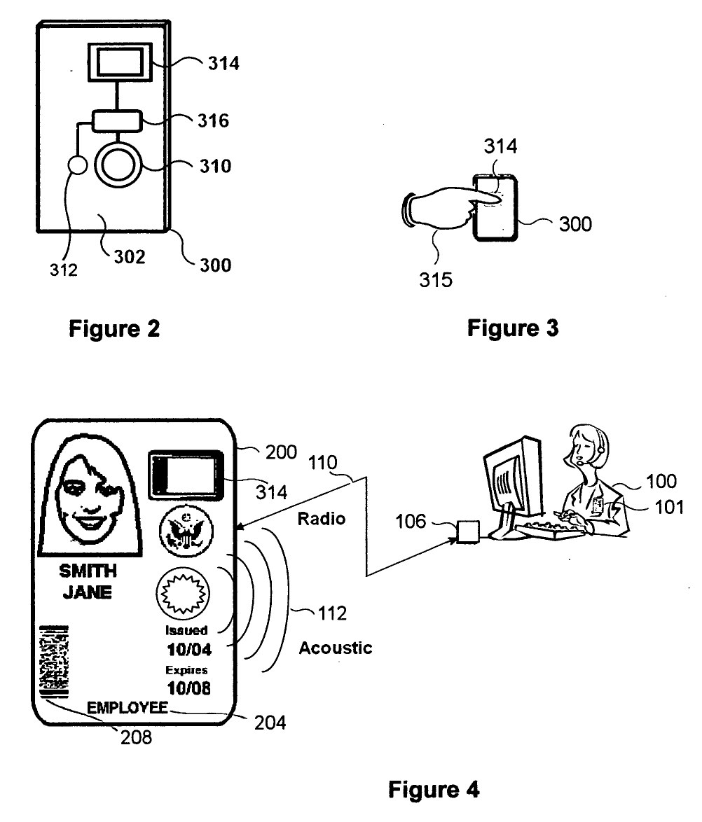

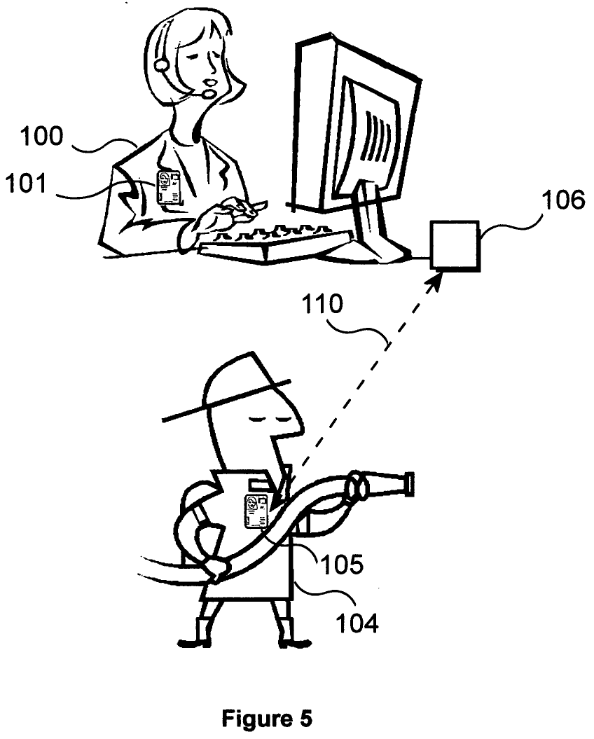

100 shows a first badgeholder (operator/dispatcher), enrolled on identification badge 101
102 shows a second badgeholder (doctor), enrolled on identification badge 103
104 shows a third badgeholder (fireman), enrolled on identification badge 105
109 shows a fourth badgeholder (policeman), enrolled on identification badge 107
106 shows an alerting/monitoring control console for badge enrollment & alerts transmission
108 shows verbal alerts & audio alerts sent from console 106 to all badgeholders
   FIG. 2 Numerals:
300 badge
302 badge substrate
310 speaker
312 microphone
314 fingerprint authentication sensor
316 microprocessor or digital signal processor (DSP)
   FIG. 3 Numerals:
300 badge
314 fingerprint authentication sensor
315 an authorized user submitting an index finger for fingerprint authentication
   FIG. 4 Numerals:
200 badge
204 pictographic pixel data indicia for badgeholder identification
208 pixel badgeholder identification pattern or barcode indicia
112 generated acoustic sound waves from speaker 310
314 fingerprint authentication sensor
110 shows radio signal transmitting a verbal alert from console 106 to badge 200
   FIG. 5 Numerals:
101 badge for badgeholder 100 (e.g., operator or dispatcher)
105 badge for badgeholder 104 (fireman)
110 audio alert generated from “two way” badge by fireman 104
106 alert monitoring and controlling console (local or central station)

Turning now to FIG. 1, four badgeholders with addressable badges are shown, as well as a multifunctional, combination enrollment/alert generation console 106. The badgeholders shown are a dispatcher, badgeholder 100 at console 106 having assigned badge 101; a doctor on call, badgeholder 102 with assigned badge 103; a “first-responder” fireman, badgeholder 104 with assigned badge 105; and another “first-responder” policeman, badgeholder 109 with assigned badge 107. The enrollment/alert generation console 106 can be provisioned either “combined” (shown) or separately (not shown). Console 106 for enrollment and for communicating and generating alerts can be implemented locally in a controlled facility—i.e., “local” to a population of badgeholders and badges being monitored and controlled. Alternatively, console 106 can be remotely provisioned, e.g., as part of a centralized, regional and/or distributed badge monitoring and control system. This figure depicts an abbreviated version of the overall system populated with four badgeholders; however, any practicably-sized number of badgeholders and badges can be included in customized versions of the system of the invention.

FIG. 1 also shows badgeholder 100—in this case an operator/dispatcher who is the system administrator—accessing an alerting and monitoring control console 106 for both badge enrollment and for generating and communicating alerts and messages to badgeholders. Badgeholder 100 is depicted here generating and communicating radio alert message 108 for broadcast to all badgeholders. To further alert badgeholders, an “attention tone” may be sent before and after the announced alert message. The attention (i.e., alarm) alert tones sounded by the badge of the present invention, can e.g., consist of “audio beeps” (in the case of FIG. 1), which are remotely originated at console 106. However, any custom version of the attention or alarm alert tones can be implemented in badges of the present invention, with details/configurations depending on needs/decisions/implementations of the controlled facility. The primary purpose of alert tones is to provide a “backup” alerting function in addition to basic verbal audio message alerts. This way, if any badgeholder misses all or part of the basic verbal audio message alert—but hears the alert tones—they can pick up a phone to the system administrator, security watch, etc., to obtain the alert message. Alternately, in advanced versions of the present invention with two-way communications capabilities, the badgeholder can contact another badgeholder and/or the system administrator to obtain the verbal audio message alert that they did not hear.

Separately, is also anticipated that more advanced versions of the invention can be implemented, where a separate LED display (not shown) can be provided to blink when any remotely-originated message is pending and may be extinguished by command from the center or the badgeholder touching a button or fingerprint authenticator 314.

FIG. 2 shows a close-up view of badge 300, one version of the badge of the present invention, implemented on a badge substrate 302—such as a plastic substrate or other “platform” substrates commonly used in credit cards, smartcards, etc. In practice, generally, any substrate appropriate for implementing smartcards and credit cards can be used to implement the badge product of the present invention.

Additionally, it is observed that badge 200 also has implemented on badge substrate 202, pictographic pixel data 204 as well as steganographic pixel data or barcode data 208, all of which are easily visible, visual data indicia for badgeholder identification. Also implemented on badge 200, is speaker 310, used for audibly sounding audio alert sounds, alarm alerts sounds, and optionally, verbal audio messages. Depending on configuration details, alternative badgeholder identifying data can be implemented, e.g., holographic data (such as a holographic seal or decal); and/or e.g., DNA data, for identifying a badgeholder by comparing a DNA sample on the badge with the actual badgeholder's DNA. Otherwise stated, holographic badgeholder identifying indicia and/or DNA badgeholder identifying indicia can be included on the badge of the present invention (not shown). Other identification modalities are contemplated, depending on the needs of the implementing facility; accordingly, this disclosure is not limited only by the express itemization of badgeholder identifying indicia set forth herein.

FIG. 3 shows a finger placed upon the fingerprint sensor 314 of card 300, biometrically identifying the cardholder and enabling badge communications. The active presence of this communications link positively authenticated the badgeholder to the center for access control or other identity purposes and also keeps the communications link private. In this way, badge theft cannot result in misuse of badge communications. Fingerprint cards are well known to the art as taught in U.S. Pat. No. 4,582,985. to Lofberg. Other forms of biometrics are also possible in the present invention, for example, a heartbeat sensor could be used as a biometric badgeholder identifying modality (not shown). There are a variety of ways that a heartbeat monitor could interface with a properly-customized version of the badge of the present invention, e.g., a separate heartbeat measuring device could be “jacked” into the badge of the present invention, and the badgeholder can submit themselves for monitoring which can be compared to the stored heartbeat pattern clip stored in memory on the badge. Of course, such a version of the badge would obviously require the addition of a jack aperture on the card and would require the separate heartbeat monitor to provide leads to “jack into” the jack aperture on the card (not shown).

FIG. 4, as stated above, depicts badge 200, disposed upon badge substrate 302. Badge 200 also implements fingerprint authentication sensor 314. This configuration allows biometric fingerprint authentication of the badgeholder (and/or other authorized badge 200 users). NB: it is not mandatory to have fingerprint sensor 314 implemented, for the badge of the present invention to be utilitarian and unique in the art. Depending on the needs of the controlled facility—non-biometric identification techniques can be used on the badge (in addition to—or in lieu of—biometric identification techniques). Non-biometric authentication can be implemented using other visual identifying indicia, also shown). FIG. 4 also shows microphone 312 implemented. Addition of the microphone option to badge 200, allows two-way communications by the badgeholder via the badge 200—resulting greater operational flexibility.

Badge 200 also implements pictographic pixel data (i.e., a picture) and barcode data 208 as additional visual badgeholder identifying indicia such as the official enrollment picture and name of “Jane Smith”. The present invention anticipates using biometric voice recognition as yet another badgeholder-identifying technique; i.e., in two-way versions of the invention, such as badge 200, during enrollment each badgeholder records voice patterns which uniquely identify him or her. The speaker's voice (with it's characteristic voice patterns) can be transmitted in the two-way communicating version of the present invention, as part of the badgeholders identification portfolio, e.g., the badgeholder can hit a “transmit sound” button (not shown) on the card when needed to accomplish “audio verification”. Alternatively, a version of badge 300 can be implemented, which automatically transmits the speaker's recognizable voice via microphone 312 to control console 106 which performs voice recognition at the central facility. The security and identification policies implemented at the central facility may call for multiple biometrics to be employed, such as fingerprint recognition and voice recognition in order to gain additional assurance of the badgeholder's identity. FIG. 4 also shows sound waves 112 associated with an audio alert, emanating from the speaker 310.

Additionally, other forms of non-biometric badgeholder identifying indicia can be included on the badge of the present invention, including magnetic stripe indicia (not shown), barcode indicia (not shown), numeric indicia (not shown), alphanumeric indicia (not shown), and/or alphabetic indicia (shown)

FIG. 5 shows the dispatcher and system administrator badgeholder 100 on duty using the unique badge identifier number to select the badge of fireman 104 for private communications. The administrator is monitoring activity at console 106 and is receiving one or more messages 110 originated from badge 105. In the scenario depicted, badge 105 is assigned to (and worn by) fireman badgeholder 104. The fireman is sending in a situation report—in this case, a verbal message—to console 106, concerning a fire emergency event, via his badge 105.

Variations on the basic concepts of the present invention may become apparent by those skilled in the art, after reading this Application. However, it is important to note, that only a few configurations of the present invention are explicitly shown herein, yet the present invention is not limited only to explicit configurations discussed herein. Additionally, it is important to note, while only “one badge” or “a badgeholder” are often referred to herein, any number of badges and badgeholders can be enrolled in any specific audio alert system or in concatenated systems, and all badges and badgeholders can be enrolled in any particular controlled facility. Furthermore, the terms “alerting and monitoring console”, “local and/or central monitoring console”, “control station”, and the like, are used essentially interchangeably. Also, the Inventor anticipates that, in badgeholder-authenticating versions of the present invention, one or more other types of biometric sensors may be usable in the present invention, e.g., a biometric fingerprint sensor, a biometric voiceprint sensor, a biometric heartbeat sensor, or any other biometric sensor which can be implemented in a card-sized form factor. Also, one or more additional authentication and verification ameliorations can be used with the present invention, including simple PIN numbers for user identification, etc. Also, other identification indicia modalities known in the art can be used, e.g., holographic seals and decals, etc. Consequently, this Application is not limited to only that which is explicitly described herein. Finally, it must be noted that the terms “audio alerts”, “alerts”, “alerting”, and the like, are used essentially interchangeably and such alerts can be data alerts, voice alerts, tone sound alerts, or any other type of communicable sound.

It is also important to note, that depending on details of configuration and customization, individual badges of the present invention can be customized to be individually and uniquely addressable by an alert originator (i.e., an alert origination facility, central console, and/or alerting and monitoring console.) In this way, as few badges as one badge can be communicated with by the alert originator; but on the other hand, as many as all badges (or one or more subgroups of all badges) can be communicated with in “broadcast” mode or “partial broadcast” mode by the alert originator/alert origination facility/local or central control console, etc.

It is further important to note, that in the badge of the present invention, some badgeholder identifying data which is not disposed upon the obverse or reverse sides of the badge, can be stored in the memory of the processor aboard the badge. Typically, badgeholder identifying data that is stored in the memory of the processor is stored biometric data which can be compared with the badgeholder's inputted data, e.g., in badges with fingerprint authentication capabilities, a badgeholder will initially enroll their fingerprint data into the card when issued a card and the data will be stored in processor memory; subsequently, when enabling/accessing the badge, the badgeholder will submit their fingerprint biometric to their card for fingerprint authentication. Finally, there are many different ways where a badgeholder can be identified and verified at their card. Another way this is done is with PIN numbers, unique numbers that the badgeholder must input into the badge via a keypad (not shown) to access the badge.

1. An identification badge for receiving audio alerts addressed to a badgeholder, comprising:
an identification badge platform substrate;
at least one form of badgeholder identifying indicia further comprising data for uniquely identifying a badgeholder; and
an electronic circuit, further comprising a radio receiver having an antenna, a data processor, an audio speaker for providing audio alerts, and a power source.

2. The identification badge of claim 1, wherein said electronic circuit further comprises a microphone for receiving audio responses from said badgeholder and a transmitter for sending said responses to an alert originator, and wherein said electronic circuit is adapted for two-way communications by addition of said microphone and said transmitter.

3. The identification badge of claim 1, wherein a button must be pushed to enable transmission of said responses to said alert originator.

4. The identification badge of claim 2, wherein a button must be pushed to enable transmission of said responses to said alert originator.

5. The identification badge of claim 1, further comprising a fingerprint sensor for authenticating at least one badgeholder fingerprint input.

6. The identification badge of claim 2, further comprising a fingerprint sensor for authenticating at least one badgeholder fingerprint input.

7. The identification badge of claim 1, wherein said at least one form of badgeholder identifying indicia further comprises pixel data.

8. The identification badge of claim 2, wherein said at least one form of badgeholder identifying indicia further comprises pixel data.

9. The identification badge of claim 7, wherein said at least one form of badgeholder identifying indicia comprising pixel data further comprises badgeholder pictographic pixel indicia.

10. The identification badge of claim 8, wherein said at least one form of badgeholder identifying indicia comprising pixel data further comprises badgeholder pictographic pixel indicia.

11. The identification badge of claim 7, wherein said at least one form of badgeholder identifying indicia comprising pixel indicia further comprises visual steganographic indicia.

12. The identification badge of claim 8, wherein said at least one form of badgeholder identifying indicia comprising pixel indicia further comprises visual steganographic indicia.

13. The identification badge of claim 1, wherein said at least one form of badgeholder identifying indicia further comprises barcode indicia.

14. The identification badge of claim 2, wherein said at least one form of badgeholder identifying indicia further comprises barcode indicia.

15. The identification badge of claim 1, wherein said at least one form of badgeholder identifying indicia further comprises magnetic stripe indicia.

16. The identification badge of claim 2, wherein said at least one form of badgeholder identifying indicia further comprises magnetic stripe indicia.

17. The identification badge of claim 1, wherein said at least one form of badgeholder identifying indicia further comprises at least one of numeric indicia and alphabetic indicia and alphanumeric indicia.

18. The identification badge of claim 2, wherein said at least one form of badgeholder identifying indicia further comprises at least one of numeric indicia and alphabetic indicia and alphanumeric indicia.

19. The identification badge of claim 1, wherein said at least one form of badgeholder identifying indicia further comprises organic indicia.

20. The identification badge of claim 2, wherein said at least one form of badgeholder identifying indicia further comprises organic indicia.

21. The identification badge of claim 19, wherein said at least one form of badgeholder identifying indicia comprising organic DNA indicia further comprises DNA indicia for identifying at least one badgeholder.

22. The identification badge of claim 20, wherein said at least one form of badgeholder identifying indicia comprising organic DNA indicia further comprises DNA indicia for identifying at least one badgeholder.

23. The identification badge of claim 1, wherein said at least one form of badgeholder identifying indicia further comprises holographic indicia.

24. The identification badge of claim 2, wherein said at least one form of badgeholder identifying indicia further comprises holographic indicia.

25. The identification badge of claim 1, wherein a unique number is stored into the processor that is compared with a number received from a central station to enable badge transmission and reception only when they match.

26. The identification badge of claim 2, wherein a unique number is stored into the processor that is compared with a number received from a central station to enable badge transmission and reception only when they match.

27. The identification badge of claim 1, wherein said processor further comprises means for authenticating said at least one badgeholder by means of biometric voice recognition.

28. The identification badge of claim 2, wherein said processor further comprises means for authenticating said at least one badgeholder by means of biometric voice recognition.

29. A method for implementing and operating an identification badge for receiving audio alerts, comprising the steps of:
provisioning said identification badge with audio alert reception capabilities;
enrolling an authorized badgeholder into said identification badge;
marking said badge with unique badgeholder identifying indicia further comprising unique badgeholder identifying data;
issuing said identification badge to said authorized badgeholder;
enabling said identification badge for use by said authorized badgeholder;
and
using the badge by transmitting audio alert signals to said badge as needed to alert said authorized badgeholder.

30. The method of claim 29, wherein the step of using said badge includes the additional step of said badgeholder speaking into a microphone disposed on said badge and the further step of transmitting the voice of said badgeholder to at least one of another badgeholder and an alert originator.

31. The method of claim 29, wherein the step of provisioning said badge includes the additional step of entering a unique badge address into the memory of the processor disposed thereupon so that said badge is uniquely addressable by an alert originator.

32. The method of claim 29, wherein the step of enrolling said authorized badgeholder into said identification badge includes the step of storing said badgeholder identifying data into badge memory.

33. The method of claim 29, wherein said badgeholder is biometrically authenticated by at least one of a fingerprint sensor and a voice sensor and a heartbeat monitor.

34. The method of claim 29, wherein said badgeholder is authenticated by a push button sequence comprising a PIN.

35. A wireless identification, badging, and alert reception system, comprising:
at least one identification badge with audio alert reception capabilities;
at least one authorized badgeholder enrolled into said at least one badge;
at least one monitoring console for badge monitoring, badge enrollment, alert origination; and
at least one predetermined method for authenticating authorized badgeholders and for communicating with a plurality of badges having unique individual addresses and having audio alert reception capabilities.

36. The system of claim 35, wherein said badge further comprises a microphone and a transmitter and wherein said badge is capable of transmitting responses from said microphone to said monitoring console.

37. The system of claim 36, wherein said monitoring console further comprises at least one of a local and a central alert origination station.
